(19) United States
(12) Patent Application Publication
(10) Pub. No.: US 2024/0368440 A1
(43) Pub. Date: Nov. 7, 2024

(54) Methods and Bonding Agents for Forming Simulated Tropical Hardwood Panel

(71) Applicant: Greene Rev LLC, Greensboro, NC (US)

(72) Inventor: Paul D. Senior, Greensboro, NC (US)

(73) Assignee: Greene Rev LLC, Greensboro, NC (US)

(21) Appl. No.: 18/142,060

(22) Filed: May 2, 2023

(51) Int. Cl. C09J 129/04; B32B 7/12; B32B 21/13; B32B 37/06; B32B 37/12

(52) U.S. Cl. CPC C09J 129/04; B32B 7/12; B32B 21/13; B32B 37/06; B32B 37/1207; B32B 37/1284; B32B 2255/08; B32B 2255/26; B32B 2309/02; B32B 2309/04

(57) ABSTRACT

A method of forming an engineered veneer block includes stacking a plurality of laminate layers and resistive heating the stack of the plurality of laminate layers to cure an adhesive in the plurality of laminate layers.

### BACKGROUND

### 1. Technical Field

The present disclosure relates to simulated hardwood panels and, more specifically, to methods and bonding agents for forming simulated tropical hardwood panels.

### 2. Discussion of Related Art

Some plywood panels used in the construction industry, furniture industry, cabinet industry, and the like commonly include one or more plies of tropical hardwoods. One example of such a plywood panel is Lauan plywood. Lauan plywood is typically used for non-decorative applications such as flooring underlayment, internal or hidden portions of furniture and cabinetry, and the like. Lauan plywood and similar plywoods are a commodity product sold by lumber supply wholesalers and retailers. Traditionally, Lauan plywood panels and other similar plywood panels include one or more tropical hardwood plies produced from wood harvested from tropical forests located in tropical regions such as Indonesia and Malaysia. Such tropical forests have become increasingly vulnerable to the adverse consequences of environmentally destructive tree harvesting practices. Such harvesting practices can lead to severe soil erosion, increased incidents of illegal logging, and poor soil fertility, for example.

For these reasons, substantial efforts are being made to significantly reduce or eliminate the importation and sale of products that contain tropical hardwoods harvested from endangered tropical forests. In particular, there is a demand for substitute wood products that include little or no wood from endangered tropical forests, and instead include wood from sustainable sources of wood (the term “sustainable source(s) of wood” is defined below). Accordingly, there is a need for hardwood plywood panels that include no tropical hardwoods from endangered tropical forests and instead include wood from one or more sustainable sources of wood. More specifically, there is a need for a simulated commodity tropical hardwood-based panel that includes no tropical hardwood from non-sustainable wood sources, yet has the visual appearance of the tropical hardwood panel that it replaces. Purchasers and users of such a simulated commodity tropical hardwood-based panel may have difficulty differentiating between the simulated commodity tropical hardwood-based panel and a commodity tropical hardwood-based panel that it replaces.

### SUMMARY

In an embodiment of the present disclosure, a method of forming an engineered veneer block includes stacking a plurality of laminate layers and resistive heating the stack of the plurality of laminate layers to cure an adhesive in the plurality of laminate layers.

In embodiments, resistive heating the stack of the plurality of laminate layers includes passing electrical energy through the stack of the plurality of laminate layers to heat the stack to a temperature in a range of 36 degrees Celsius to 40 degrees Celsius. Resistive heating may include maintain the temperature in a range of 36 degrees Celsius to 40 degrees Celsius in a range of 3 to 6 days.

In other embodiments, resistive heating the stack of the plurality of laminate layers includes contacting the topmost surface of the plurality of laminate layers with a first conductor, contacting a bottommost surface of the plurality of laminate layers with a second conductor, and providing electrical energy to at least one of the first conductor or the second conductor such that electrical energy passes through the stack of the plurality of laminate layers between the first conductor and the second conductor. The electrical energy may be direct current or alternating current.

In certain embodiments, the method includes spreading a bonding agent on one or more of the plurality of laminate layers before stacking the plurality of laminate layers. The method may include cold pressing the plurality of laminate layers before resistive heating the stack of the plurality of laminate layers. The method may include mixing the bonding agent before spreading the bonding agent on the one or more of the plurality of laminate layers. Mixing the bonding agent may include determining an among of water in the bonding agent based on a moisture content of the plurality of laminate layers.

In particular embodiments, mixing the bonding agent includes mixing a permeating agent with the adhesive. The permeating agent may improve permeation of the adhesive and moisture into the plurality of laminate layers. Mixing the bonding agent may include adding an adhesive having greater than 16 percent Urea. Mixing the bonding agent may include adding an adhesive having 50 percent or less water. Mixing the bonding agent may include adding an adhesive having less than 31 percent formaldehyde.

In another embodiment of the present disclosure, a bonding agent for forming an engineered veneer block includes an adhesive and a permeating ageing. The permeating agent is configured to improve permeation of the adhesive and moisture through wood.

In embodiments, the permeating agent includes 35 percent or more of polyvinyl alcohol and 15 percent or more vinyl acetate. The adhesive may include less than 331 percent formaldehyde. The adhesive may include greater than 16 percent Urea. The adhesive may include 50 percent or less water. The bonding agent may include water based on the moisture content of wood to be bonded.

In another embodiment of the present disclosure, an engineered veneer includes a plurality of strips of laminate layers and a cured bonding agent bonding the plurality of strips of the laminate layers together to form the engineered veneer. The engineered veneer emitting less than 0.15 parts per million formaldehyde as measured by EPA Method 323—Formaldehyde Measurement Using Derivatization.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a flowchart of a method of forming an Engineered Veneer provided in accordance with the present disclosure;

FIG. 2 is a perspective view of laminate layers;

FIG. 3 is a perspective view of a laminate layer with a bonding agent applied thereto;

FIG. 4 is a perspective view of a stack of laminate layers in a cold pressing machine;

FIG. 5 is a perspective view of the stack of laminate layers in a heating system; and

FIG. 6 is an enlarged view of the stack of laminate layers of FIG. 5.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

This disclosure relates to the forming an Engineered Veneer (EV) Block with a plurality of laminate layers that are stacked and adhered to one another. The EV Block is then sliced to form an EV that simulates a tropical hardwood such as Lauan. The EV Block may be sliced at an angle relative to the laminate layers. In some embodiments, the EV Block may be sliced perpendicular to the laminate layers, plain sliced, or sliced at a variety of angles to obtain a desired appearance of the EV. The EV may include a thin segment of each of the plurality of laminate layers. The EV may bond to a panel core such that the panel simulates a tropical hardwood panel.

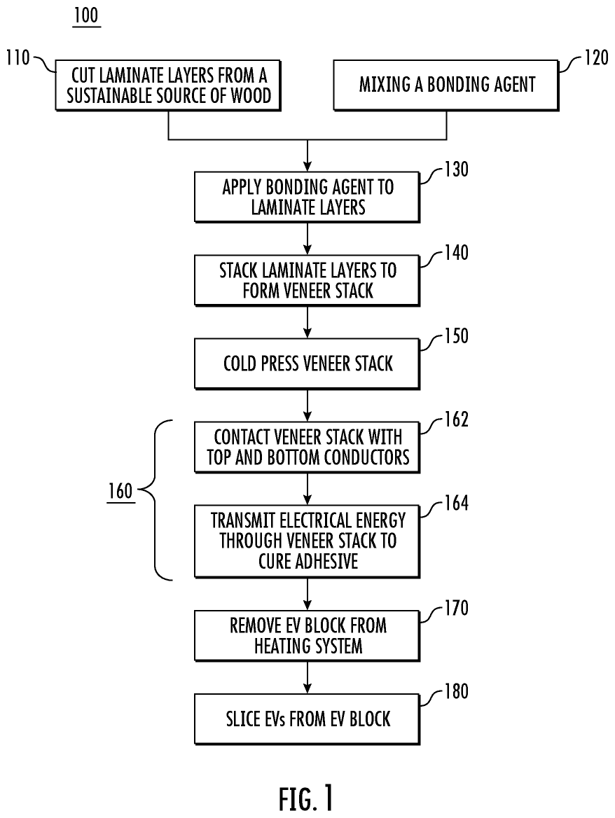

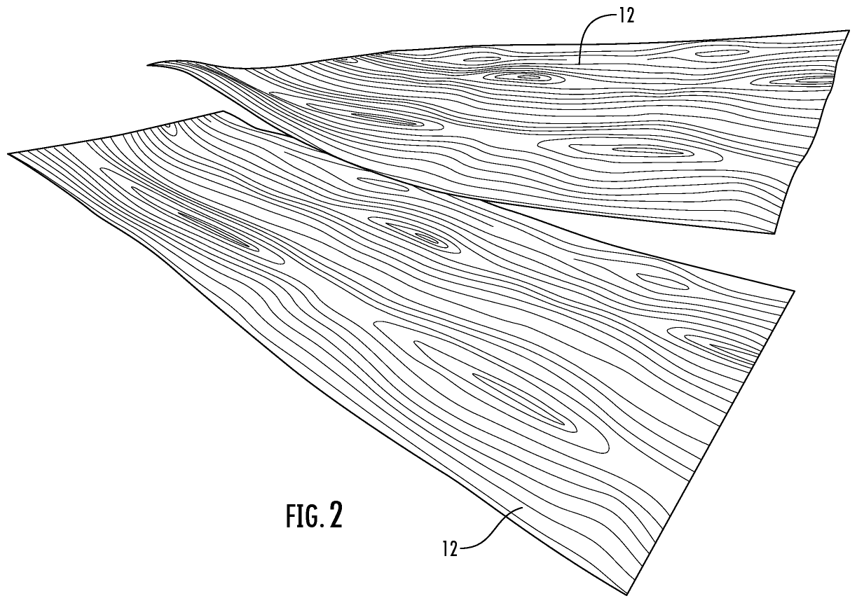

Referring to FIGS. 1-6, a method 100 of forming an Engineered Veneer (EV) block 10 is described in accordance with the present disclosure. The EV block is formed by a plurality of laminate layers 12 that are stacked and bonded together with one or more adhesives. The laminate layers 12 are each thin slices of a sustainable source of wood. The laminate layers 12 may be from a single source of wood or may be from multiple sources or types of wood that are stacked and bonded to form the EV block as detailed below. The method 100 may include cutting the laminate layers 12 from the source or sources of wood (Step 110). The laminate layers 12 may be in a range of 0.5 mm to 1.5 mm thick as shown in FIG. 2.

The method 100 includes mixing a bonding agent to bond the laminate layers 12 together (Step 120). The bonding agent may include water, an adhesive, and a permeating agent. The permeating agent may assist the adhesive and moisture in permeating through the wood of the laminate layers 12. The bonding agent may include significantly less water than previous bonding agents. In some embodiments, the bonding agent may include added water. Mixing the bonding agent may include pouring the components of the bonding agent into a stirring machine and stirring the components until the components are evenly and completely mixed. The bonding agent may be stirred at room temperature. The bonding agent may be stirred in a range of 10 to 20 minutes to mix the bonding agent.

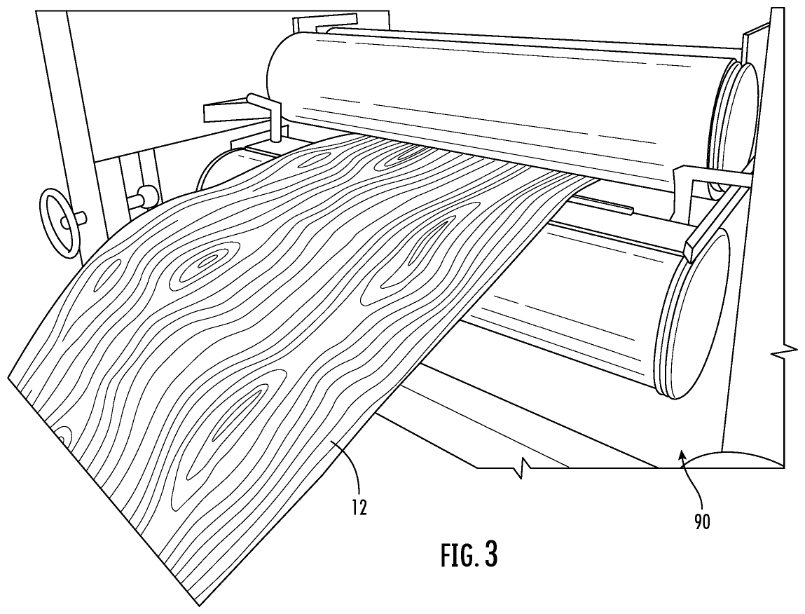

When the bonding agent is mixed and the laminate layers 12 are cut, the bonding agent is applied to the laminate layers 12 (Step 130). The bonding agent may be applied to the laminate layers 12 by loading a spreading machine 90 with the bonding agent and passing one or more of the laminate layers 12 through the spreading machine 90 as shown in FIG. 3. Each laminate layer 12 may be passed through the spreading machine 90 to have the bonding agent applied thereto.

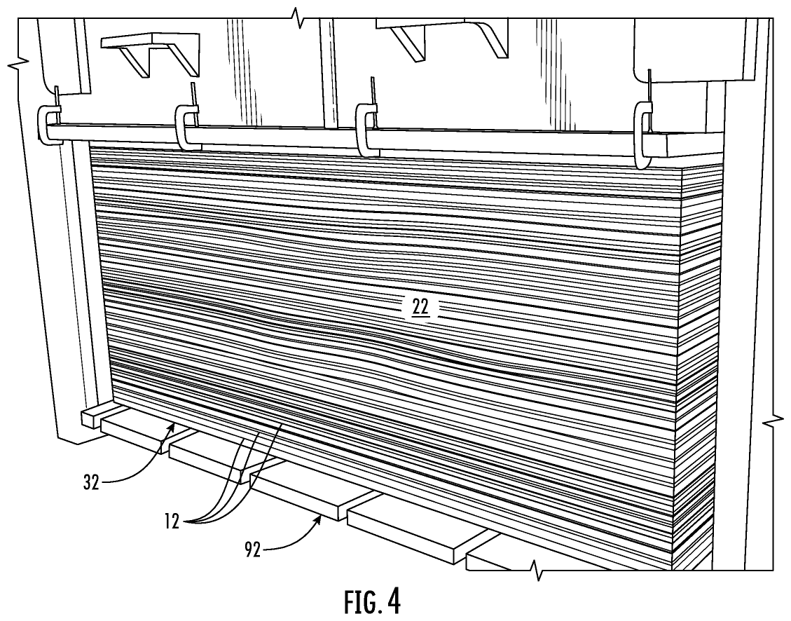

As the laminate layers 12 are passed through the spreading machine 90, the laminate layers 12 are stacked on top of one another to form a veneer stack 22 as shown in FIG. 4 (Step 140). In embodiments where every layer is passed through the spreading machine 90, the laminate layers 12 may be stacked as each layer comes out of the spreading machine 90. In some embodiments, the bonding agent permeates through the laminate layers 12. In certain embodiments, the laminate layers 12 may be inspected for damage and repaired or discarded before being placed in the veneer stack 22 or passed through the spreading machine 90.

The laminate layers 12 are stacked until the veneer stack 22 reaches a desired thickness for the EV block 32. For example, each laminate layer 12 may have a length in a range of 2500 mm (98 inches) to 2600 mm (102 inches), e.g., 2560 mm (100 inches), a width in a range of 680 mm (26.5 inches) to 760 mm (30 inches), e.g., 720 mm (28 inches), and a thickness in a range of 0.85 mm (0.033 inches) to 1 mm (0.04 inches). The veneer stack 22 may include a range of 1600 to 1900 laminate layers 12 such that the veneer stack 22 has a total height in a range of 1200 mm (47 inches) to 1400 mm (55 inches), e.g., 1300 mm (51 inches).

With particular reference to FIG. 3, with the veneer stack 22 formed, the veneer stack 22 is placed in a cold pressing machine 92. In some embodiments, the laminate layers 12 are stacked in the cold pressing machine 92. The cold pressing machine 92 is activated to press the veneer stack 22 to compress the laminate layers 12 together and allow the bonding agent to permeate through all of the laminate layers 12 (Step 150). The cold pressing machine 92 may apply a range of 800 kilopascals (kPa) to 5000 kPA to compress the laminate layers 12 in a range of 3 to 6 hours, e.g., 4 to 5 hours.

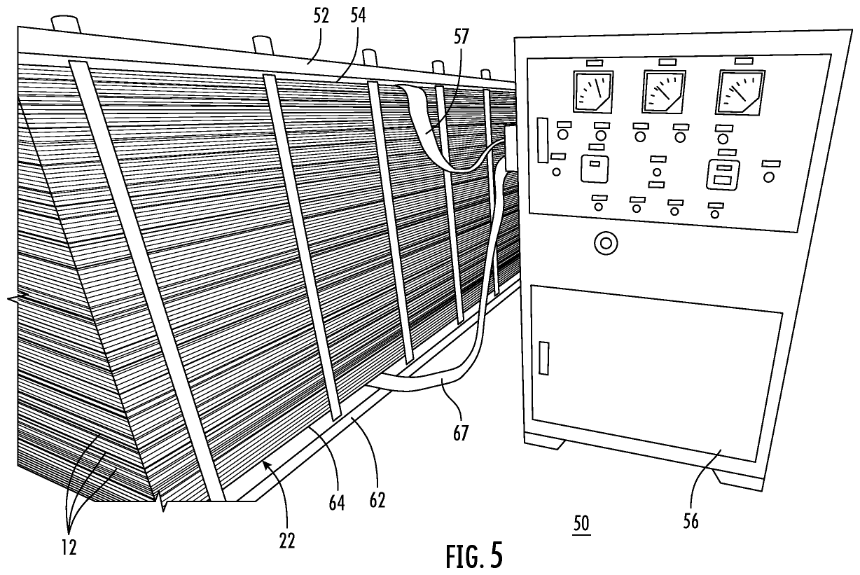

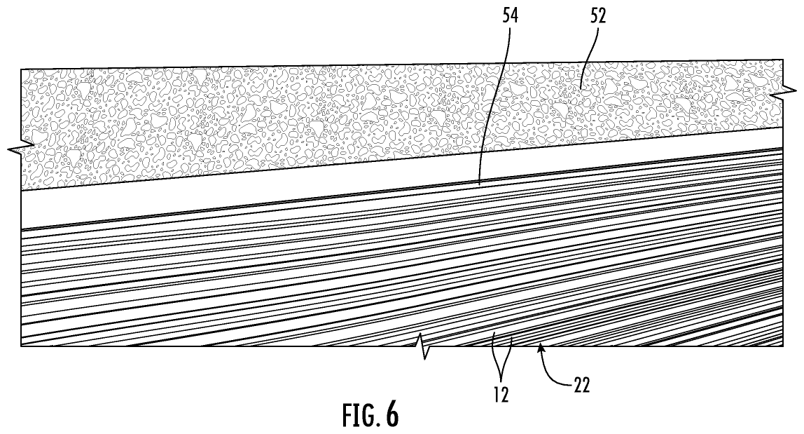

Referring now to FIGS. 5 and 6, the compressed veneer stack 22 placed in a heating system 50 which is provided in accordance with the present disclosure. The heating system 50 is used to heat the veneer stack 22 to cure the adhesive in the bonding agent (Step 160). The heating system 50 includes a top insulator 52 and a bottom insulator 62. The insulators 52, 62 may be formed of concrete, cement, rubber, wood, composite, or a combination of materials. In some embodiments, the insulators 52, 62 are formed of multiple materials which may include a conductive material and an insulative material. For example, one or both of the insulators 52, 62 may include a metal base (steel, lead, or stainless steel) and an insulative coating (rubber, polymer, or wood) facing the veneer stack 22. The heating system 50 also includes a top conductor 54 in contact with the topmost laminate layer 12 and a bottom conductor 54 in contact with the bottommost laminate layer 12. The conductors 54, 64 may be a sheet that is in contact with the entire top or bottom surface of the respective laminate layer 12. The conductors 54, 64 may be formed of a variety of highly conductive materials such as aluminum, silver, copper, or gold. For example, the conductors 54, 64 may be aluminum sheets. The conductors 54, 64 may have a thickness of 2.5 mm. In certain embodiments, the conductors 54, 64 may be formed as part of the insulators 52, 62 such that the conductors 54, 64 are secured to the insulators 52, 62 in opposition to one another with the veneer stack 22 disposed therebetween.

The heating system 50 includes a power source 56 that is in electrical communication with the top conductor 54 and the bottom conductor 64. The power source 56 may be in electrical communication with the top conductor 54 and the bottom conductor 64 by a top wire belt 57 and a lower wire belt 67 that are each connected to a respective one of the top conductor 54 and the bottom conductor 64. The top wire belt 57 and the lower wire belt 67 may include a plurality of connectors that connect to multiple locations along the edges of the respective top conductor 54 or the bottom conductor 64 to electrically couple to the conductors 54, 64, Connecting to multiple locations on the conductors 54, 64 may improve a distribution energy across the surface of the conductors 54, 64 in contact with the veneer stack 22.

With veneer stack 22 placed in the heating system 50, the top conductor 54 and bottom conductor 64 are placed in contact with the topmost and bottom most surfaces, respectively, of the veneer stack 22 (Step 162). With the conductors 54, 64 in contact with the surfaces of the veneer stack 22, the heating system 50 is activated to transmit electrical energy through the veneer stack 22 to heat the veneer stack 22 (Step 164). The veneer stack 22 may act as a resistor in between the conductors 54, 64 such that the veneer stack 22 is heated by resistive heating. In embodiments, the power source 56 provides electrical energy in the form of direct current with one of the conductors 54, 64 acting as an anode and the other of the conductors 54, 64 acting as a cathode. In some embodiments, the power source 56 provides electrical energy in the form of alternating current with one of the conductors 54, 64 acting as an anode/cathode and the other of the conductors 54, 64 acting as the ground. The power source 56 may provide electrical energy sufficient to heat the veneer stack 22 to a temperature in a range of 36 degrees Celsius to 40 degrees Celsius, e.g., 38 degrees Celsius. The temperature of the veneer stack 22 may be measured by one or more sensors disposed on, in, or about the veneer stack 22. In some embodiments, the temperature of the veneer stack 22 may be calculated based at least partially on an amount of power provided by the power source 56. The temperature of the veneer stack 22 is maintained for a predetermined amount of time to fully cure the adhesive of the bonding agent. The predetermined amount of time may in a range of 3 to 6 days, e.g., 4 to 5 days. The top and/or bottom conductors 54, 64 may apply pressure to the veneer stack 22 while the veneer stack 22 is heated.

After the predetermined amount of time, the veneer stack 22 forms the EV block 32. When the EV block 32 is formed, the EV block 32 is removed from the heating system 50 (Step 170). The EV block 32 is then sliced into an EV (Step 180). Each EV may include strip of substantially all of the laminate layers 22 of the EV block 32. Each EV may be sized to form the surface of a layered building material, e.g., plywood, such that the layered building material resembles a tropical hardwood panel but is formed of sustainable wood sources, e.g., Lauan.

The method 100 detailed above includes heating the veneer stack 22 by resistive heating. This is an improvement over the traditional heating of veneer stacks 22 by placing the veneer stack 22 in a steam kiln. Using resistive heating to heat the veneer stack 22 may use less energy than heating a steam kiln. Using resistive heating may quickly heat the entire veneer stack 22 evenly. In contrast, it may take a long time for heat of a steam kiln to penetrate the entire veneer stack 22. Heating the veneer stack 22 with resistive heating may reduce the time required to cure the adhesive. Specifically, it may take 8 to 9 days in a steam kiln to cure adhesive in a veneer stack 22 compared to 3 to 6 days using resistive heating. Evenly curing the adhesive may decrease failures when slicing the EV block 32.

The bonding agent used in the method 100 detailed above, may be an improvement over previous bonding agents. For example, previous bonding agents may include polyvinyl acetate, adhesive, and water. The previous bonding agents could be hard to control and difficult to cure. The previous bonding agents could cause the EV block to fall apart or split when sliced. The previous bonding agents could create a rigid EV block that is difficult to slice and/or create a rough surface when the EV block is sliced.

The bonding agent for the EV block may include less water than previous bonding agents. In some embodiments, the formulation of the bonding agent may be based on the moisture content (MC) of the laminate layers 12. In certain embodiments, the bonding agent may not include any water. The bonding agent may include a permeating agent to permeate through the wood of the laminate layers 12. The permeating agent may include vinyl acetate and polyvinyl alcohol as major components thereof. In particular embodiments, the permeating agent may be formulated to include 35 percent or more percent polyvinyl alcohol, e.g., 35, 40, 45, or 50 percent, and 15 percent or more vinyl acetate, e.g., 15, 20, 25, or 30 percent. In some embodiments, the permeating agent may include propylene glycol, unsaturated polyester resin, and/or water. In certain embodiments, the permeating agent includes 10 percent or less water.

The bonding agent may be formulated to include the permeating agent in a range of 0.7 to 1 percent, water in a range of 0 to 3 percent, and adhesive in a range of 96 to 99 percent. The improved bonding agent may allow the adhesive and/or moisture permeate the wood better than previous bonding agents. In some embodiments, the bonding agent may make the finished EV block 32 more flexible and/or more suitable for slicing than previous bonding agents.

As detailed above, the bonding agent used in method 100 may be improved by the inclusion of the permeating agent. In addition to improving the bonding agent, the method 100 may use an improved adhesive. Specifically, the improved adhesive may decrease emission of formaldehyde from the final engineered veneer. For example, the first and second adhesives disclosed herein may emit of less than 0.15 ppm or 0.05 ppm as measured using EPA Method 323—Formaldehyde Measurement Using Derivatization. In contrast, veneers made with the previous adhesives may emit less than 0.5 ppm formaldehyde or three to ten times as much formaldehyde. The formulation of the adhesives may be as follows:

| | Previous | First | Second |
|---|---|---|---|
| Component | Adhesive | Adhesive | Adhesive |
| Urea | 2.10% | 16.67% | 23.32% |
| Formaldehyde | 40.68% | 30.95% | 29.15% |
| melamine | 0.00% | 2.14% | 2.19% |
| ammonium hydroxide | 2.17% | 0.00% | 0.00% |
| polyvinyl alcohol | 0.05% | 0.24% | 0.34% |
| water | 55.00% | 50.00% | 45.00% |

As shown in the table above, the amount of formaldehyde is reduced from the previous adhesives to the first adhesive and further to the second adhesive. Specifically, the first and second adhesives have less than 31 percent formaldehyde. In addition, the table shows that increasing the Urea in the adhesive may reduce formaldehyde emissions from the adhesive. Specifically, the first adhesive and the second adhesive may include greater than 16 percent Urea. Further, the table shows that the first and second adhesive are free of ammonium hydroxide and both include melamine. The first and second adhesives may include 50 percent or less of water.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

1. A method of forming an engineered veneer block, the method comprising:
stacking a plurality of laminate layers; and
resistive heating the stack of the plurality of laminate layers to cure an adhesive in the plurality of laminate layers by transmitting electrical energy through an entire thickness of each laminate layer of the stack of the plurality of laminate layers.

2. The method according to claim 1, wherein resistive heating the stack of the plurality of laminate layers includes passing electrical energy through the stack of the plurality of laminate layers to heat the stack to a temperature in a range of 36 degrees Celsius to 40 degrees Celsius.

3. The method according to claim 2, wherein resistive heating includes maintaining the temperature in a range of 36 degrees Celsius to 40 degrees Celsius in a range of 3 to 6 days.

4. The method according to claim 1, wherein resistive heating the stack of the plurality of laminate layers comprises:
contacting a topmost surface of the plurality of laminate layers with a first conductor;
contacting a bottommost surface of the plurality of laminate layers with a second conductor; and
transmitting the electrical energy to at least one of the first conductor or the second conductor such that the electrical energy passes through the entire thickness of each laminate layer of the stack of the plurality of laminate layers between the first conductor and the second conductor.

5. The method according to claim 4, wherein the electrical energy is direct current.

6. The method according to claim 1, further comprising spreading a bonding agent on one or more of the plurality of laminate layers before stacking the plurality of laminate layers.

7. The method according to claim 6, further comprising cold pressing the plurality of laminate layers before resistive heating the stack of the plurality of laminate layers.

8. The method according to claim 6, further comprising mixing the bonding agent before spreading the bonding agent on the one or more of the plurality of laminate layers.

9. The method according to claim 8, wherein mixing the bonding agent includes determining an amount of water in the bonding agent based on a moisture content of the plurality of laminate layers.

10. The method according to claim 8, wherein mixing the bonding agent includes mixing a permeating agent with the adhesive, the permeating agent which improves permeation of adhesive and moisture into the plurality of laminate layers.

11. The method according to claim 8, wherein mixing the bonding agent includes adding an adhesive having greater than 16 percent Urea.

12. The method according to claim 8, wherein mixing the bonding agent includes adding an adhesive having 50 percent or less water.

13. The method according to claim 8, wherein mixing the bonding agent includes adding an adhesive having less than 31 percent formaldehyde.

14. A bonding agent for forming an engineered veneer block, the bonding agent comprising:
an adhesive; and
a permeating agent configured to improve permeation of the adhesive and moisture through wood.

15. The bonding agent according to claim 14, wherein the permeating agent includes 35 percent or more of polyvinyl alcohol and 20 percent or more vinyl acetate.

16. The bonding agent according to claim 14, wherein the adhesive includes less than 31 percent formaldehyde.

17. The bonding agent according to claim 14, wherein the adhesive includes greater than 16 percent Urea.

18. The bonding agent according to claim 14, wherein the adhesive includes 50 percent or less water.

19. The bonding agent according to claim 14, further comprising water based on the moisture content of wood to be bonded.

20. An engineered veneer comprising:
a plurality of strips of laminate layers; and
a cured bonding agent bonding the plurality of strips of the laminate layers together to form the engineered veneer, the engineered veneer emitting less than 0.15 parts per million formaldehyde as measured by EPA Method 323—Formaldehyde Measurement Using Derivatization.
